(19) United States
(12) Patent Application Publication
(10) Pub. No.: US 2014/0278392 A1
(43) Pub. Date: Sep. 18, 2014

(54) Method and Apparatus for Pre-Processing Audio Signals

(71) Applicant: Motorola Mobility LLC, Libertyville, IL (US)

(72) Inventors: Tenkasi V. Ramabadran, Oswego, IL (US); Joel A. Clark, Woodridge, IL (US); Patrick J. Gries, Lakewood, IL (US); Mark A. Jasiuk, Chicago, IL (US)

(73) Assignee: Motorola Mobility LLC, Libertyville, IL (US)

(21) Appl. No.: 13/949,333

(22) Filed: Jul. 24, 2013

Related U.S. Application Data
(60) Provisional application No. 61/776,793, filed on Mar. 12, 2013.
(60) Provisional application No. 61/798,097, filed on Mar. 15, 2013.
(60) Provisional application No. 61/819,960, filed on May 6, 2013.

(51) Int. Cl. G10L 15/20; H04W 4/02

(52) U.S. Cl. CPC G10L 15/20; H04W 4/02
USPC 704/233

(57) ABSTRACT

The disclosure is directed to pre-processing audio signals. In one implementation, an electronic device receives an audio signal that has audio information, obtains auxiliary information (such as location, velocity, direction, light, proximity of objects, and temperature), and determines, based on the audio information and the auxiliary information, a type of audio environment in which the electronic device is operating. The device selects an audio pre-processing procedure based on the determined audio environment type and pre-processes the audio signal according to the selected pre-processing procedure. The device may then perform speech recognition on the pre-processed audio signal.

### CROSS-REFERENCE TO RELATED APPLICATIONS

The present application claims the benefit of the filing date of U.S. Provisional Application No. 61/776,793, filed Mar. 12, 2013, the entire contents of which are incorporated by reference; U.S. Provisional Application No. 61/798,097, filed Mar. 15, 2013, the entire contents of which are incorporated by reference; and U.S. Provisional Application No. 61/819,960, filed May 6, 2013, the entire contents of which are incorporated by reference.

### TECHNICAL FIELD

The present disclosure relates to processing audio signals and, more particularly, to methods and devices for pre-processing audio signals.

### BACKGROUND

Although speech recognition has been around for decades, the quality of speech recognition software and hardware has only recently reached a high enough level to appeal to a large number of consumers. One area in which speech recognition has become very popular in recent years is the smartphone and tablet computer industry. Using a speech recognition-enabled device, a consumer can perform such tasks as making phone calls, writing emails, and navigating with GPS, strictly by voice.

Speech recognition in such devices is far from perfect, however. When using a speech recognition-enabled device for the first time, the user may need to “train” the speech recognition software to recognize his or her voice. Even after training, however, the speech recognition functions may not work well in all sound environments. For example, the presence of background noise can decrease speech recognition accuracy.

### DRAWINGS

While the appended claims set forth the features of the present techniques with particularity, these techniques may be best understood from the following detailed description taken in conjunction with the accompanying drawings of which:

FIG. 1 shows a user speaking to an electronic device, which is depicted as a mobile device in the drawing.

FIG. 2 shows example components of the electronic device of FIG. 1.

FIG. 3 shows an architecture on which various embodiments may be implemented.

FIG. 4 shows steps that may be carried out according to an embodiment of the invention.

### DESCRIPTION

In accordance with the foregoing, a method and apparatus for pre-processing audio signals will now be described.

According to an embodiment, an electronic device is able to select a pre-processing technique that is suited to the environment under which the device is operating. In doing so, the device enhances speech recognition accuracy. In one implementation, the device uses information obtained from the audio signal itself, and information obtained from one or more auxiliary devices.

The device is able to select from any of a number of pre-processing techniques (e.g., single microphone noise suppression, two microphone noise suppression, adaptive noise cancellation) and apply the selected technique to the audio input signal of the device. The selection of the appropriate pre-processing technique may depend on the level of background noise as well as the characteristics of the background noise (e.g., variability, spectral shape, etc.)

One or more auxiliary devices, according to an embodiment, provide additional information on which the pre-processing procedure selection may be made. For example, a Global Positioning Signal (GPS) module can provide information about the location of the device, whether the device is in motion, and its velocity. From the location and velocity of the device, clues about the level of background noise and characteristics of the background noise can be garnered. For example, the device may be located in a quiet home environment, a busy restaurant, a city street, or a highway. It may be stationary or moving at 60 mph. Based on the location and velocity of the device, information about the noise level and noise characteristics can be inferred using prior knowledge (e.g., lookup tables of stored noise levels and characteristics) under similar conditions. Such information can then be used to select the appropriate pre-processing technique for the input signal and thereby enhance the speech recognition performance.

In an embodiment, an electronic device receives an audio signal that has audio information, obtains auxiliary information (such as location, velocity, direction, light, and temperature), and determines, based on the audio information and the auxiliary information, a type of audio environment in which the electronic device is operating. The device selects an audio pre-processing procedure based on the determined audio environment type and pre-processes the audio signal according to the selected pre-processing procedure. The device may then perform speech recognition on the pre-processed audio signal.

Possible implementations for the pre-processing procedure include straight-through signal transmission, single microphone noise suppression, two microphone noise suppression, and adaptive noise cancellation.

In an embodiment, determining the type of audio environment involves determining whether the device is being operated in a vehicle, in a home, in a restaurant, in an office, or on a street.

As used herein, the “audio environment” of a device means the characteristics of the sounds audible to the device other than the sound of the user's speech. Background noise is part of the audio environment.

A “module” as used herein is software executing on hardware. A module may execute on multiple hardware elements or on a single one. Furthermore, when multiple modules are depicted in the figures, it is to be understood that the modules may, in fact, all be executing on the same device and in the same overall unit of software.

When the current disclosure refers to modules and other elements “providing” information (data) to one another, it is to be understood that there are a variety of possible ways such action may be carried out, including electrical signals being transmitted along conductive paths (e.g., wires) and inter-object method calls.

Some of the embodiments described herein are usable in the context of always-on audio (AOA). When using AOA, the device 102 (FIG. 1) is capable of waking up from a sleep mode upon receiving a trigger command from a user. AOA places additional demands on devices, especially mobile devices. Thus, AOA is most effective when the device 102 is able to recognize the user's voice commands accurately and quickly.

Referring to FIG. 1, a user 104 provides voice input (or vocalized information or speech) 106 that is received by a speech recognition-enabled electronic device (“device”) 102 by way of a microphone (or other sound receiver) 108. The device 102, which is a mobile device in this example, includes a touch screen display 110 that is able to display visual images and to receive or sense touch type inputs as provided by way of a user's finger or other touch input device such as a stylus. Notwithstanding the presence of the touch screen display 110, in the embodiment shown in FIG. 1, the device 102 also has a number of discrete keys or buttons 112 that serve as input devices of the device. However, in other embodiments such keys or buttons (or any particular number of such keys or buttons) need not be present, and the touch screen display 110 can serve as the primary or only user input device.

Although FIG. 1 particularly shows the device 102 as including the touch screen display 110 and keys or buttons 112, these features are only intended to be examples of components/features on the device 102, and in other embodiments the device 102 need not include one or more of these features and/or can include other features in addition to or instead of these features.

The device 102 is intended to be representative of a variety of devices including, for example, cellular telephones, personal digital assistants (PDAs), smart phones, or other handheld or portable electronic devices. In alternate embodiments, the device can also be a headset (e.g., a Bluetooth headset), MP3 player, battery-powered device, a watch device (e.g., a wristwatch) or other wearable device, radio, navigation device, laptop or notebook computer, netbook, pager, PMP (personal media player), DVR (digital video recorders), gaming device, camera, e-reader, e-book, tablet device, navigation device with video capable screen, multimedia docking station, or other device.

Embodiments of the present disclosure are intended to be applicable to any of a variety of electronic devices that are capable of or configured to receive voice input or other sound inputs that are indicative or representative of vocalized information.

FIG. 2 shows internal components of the device 102 of FIG. 1, in accordance with an embodiment of the disclosure. As shown in FIG. 2, the internal components 200 include one or more wireless transceivers 202, a processor 204 (e.g., a microprocessor, microcomputer, application-specific integrated circuit, etc.), a memory portion 206, one or more output devices 208, and one or more input devices 210. The internal components 200 can further include a component interface 212 to provide a direct connection to auxiliary components or accessories for additional or enhanced functionality. The internal components 200 may also include a power supply 214, such as a battery, for providing power to the other internal components while enabling the mobile device to be portable. Further, the internal components 200 additionally include one or more sensors 228. All of the internal components 200 can be coupled to one another, and in communication with one another, by way of one or more internal communication links 232 (e.g., an internal bus).

Further, in the embodiment of FIG. 2, the wireless transceivers 202 particularly include a cellular transceiver 203 and a Wi-Fi transceiver 205. More particularly, the cellular transceiver 203 is configured to conduct cellular communications, such as 3G, 4G, 4G-LTE, vis-à-vis cell towers (not shown), albeit in other embodiments, the cellular transceiver 203 can be configured to utilize any of a variety of other cellular-based communication technologies such as analog communications (using AMPS), digital communications (using CDMA, TDMA, GSM, iDEN, GPRS, EDGE, etc.), and/or next generation communications (using UMTS, WCDMA, LTE, IEEE 802.16, etc.) or variants thereof.

By contrast, the Wi-Fi transceiver 205 is a wireless local area network (WLAN) transceiver 205 configured to conduct Wi-Fi communications in accordance with the IEEE 802.11 (a, b, g, or n) standard with access points. In other embodiments, the Wi-Fi transceiver 205 can instead (or in addition) conduct other types of communications commonly understood as being encompassed within Wi-Fi communications such as some types of peer-to-peer (e.g., Wi-Fi Peer-to-Peer) communications. Further, in other embodiments, the Wi-Fi transceiver 205 can be replaced or supplemented with one or more other wireless transceivers configured for non-cellular wireless communications including, for example, wireless transceivers employing ad hoc communication technologies such as HomeRF (radio frequency), Home Node B (3G femtocell), Bluetooth and/or other wireless communication technologies such as infrared technology.

Although in the present embodiment the device 102 has two of the wireless transceivers 202 (that is, the transceivers 203 and 205), the present disclosure is intended to encompass numerous embodiments in which any arbitrary number of wireless transceivers employing any arbitrary number of communication technologies are present. By virtue of the use of the wireless transceivers 202, the device 102 is capable of communicating with any of a variety of other devices or systems (not shown) including, for example, other mobile devices, web servers, cell towers, access points, other remote devices, etc. Depending upon the embodiment or circumstance, wireless communication between the device 102 and any arbitrary number of other devices or systems can be achieved.

Operation of the wireless transceivers 202 in conjunction with others of the internal components 200 of the device 102 can take a variety of forms. For example, operation of the wireless transceivers 202 can proceed in a manner in which, upon reception of wireless signals, the internal components 200 detect communication signals and the transceivers 202 demodulate the communication signals to recover incoming information, such as voice and/or data, transmitted by the wireless signals. After receiving the incoming information from the transceivers 202, the processor 204 formats the incoming information for the one or more output devices 208. Likewise, for transmission of wireless signals, the processor 204 formats outgoing information, which can but need not be activated by the input devices 210, and conveys the outgoing information to one or more of the wireless transceivers 202 for modulation so as to provide modulated communication signals to be transmitted.

Depending upon the embodiment, the input and output devices 208, 210 of the internal components 200 can include a variety of visual, audio and/or mechanical outputs. For example, the output device(s) 208 can include one or more visual output devices 216 such as a liquid crystal display and/or light emitting diode indicator, one or more audio output devices 218 such as a speaker, alarm, and/or buzzer, and/or one or more mechanical output devices 220 such as a vibrating mechanism. The visual output devices 216 among other things can also include a video screen. Likewise, by example, the input device(s) 210 can include one or more visual input devices 222 such as an optical sensor (for example, a camera lens and photosensor), one or more audio input devices 224 such as the microphone 108 of FIG. 1 (or further for example a microphone of a Bluetooth headset), and/or one or more mechanical input devices 226 such as a flip sensor, keyboard, keypad, selection button, navigation cluster, touch pad, capacitive sensor, motion sensor, and/or switch. Operations that can actuate one or more of the input devices 210 can include not only the physical pressing/actuation of buttons or other actuators, but can also include, for example, opening the mobile device, unlocking the device, moving the device to actuate a motion, moving the device to actuate a location positioning system, and operating the device.

As mentioned above, the internal components 200 also can include one or more of various types of sensors 228 as well as a sensor hub to manage one or more functions of the sensors. The sensors 228 may include, for example, proximity sensors (e.g., a light detecting sensor, an ultrasound transceiver or an infrared transceiver), touch sensors, altitude sensors, and one or more location circuits/components that can include, for example, a Global Positioning System (GPS) receiver, a triangulation receiver, an accelerometer, a tilt sensor, a gyroscope, or any other information collecting device that can identify a current location or user-device interface (carry mode) of the device 102. Although the sensors 228 for the purposes of FIG. 2 are considered to be distinct from the input devices 210, in other embodiments it is possible that one or more of the input devices can also be considered to constitute one or more of the sensors (and vice-versa). Additionally, although in the present embodiment the input devices 210 are shown to be distinct from the output devices 208, it should be recognized that in some embodiments one or more devices serve both as input device(s) and output device(s). In particular, in the present embodiment in which the device 102 includes the touch screen display 110, the touch screen display can be considered to constitute both a visual output device and a mechanical input device (by contrast, the keys or buttons 112 are merely mechanical input devices).

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. In some embodiments, the memory portion 206 can be integrated with the processor 204 in a single device (e.g., a processing device including memory or processor-in-memory (PIM)), albeit such a single device will still typically have distinct portions/sections that perform the different processing and memory functions and that can be considered separate devices. In some alternate embodiments, the memory portion 206 of the device 102 can be supplemented or replaced by other memory portion(s) located elsewhere apart from the mobile device and, in such embodiments, the mobile device can be in communication with or access such other memory device(s) by way of any of various communications techniques, for example, wireless communications afforded by the wireless transceivers 202, or connections via the component interface 212.

The data that is stored by the memory portion 206 can include, but need not be limited to, operating systems, programs (applications), modules, and informational data. Each operating system includes executable code that controls basic functions of the device 102, such as interaction among the various components included among the internal components 200, communication with external devices via the wireless transceivers 202 and/or the component interface 212, and storage and retrieval of programs and data, to and from the memory portion 206. As for programs, each program includes executable code that utilizes an operating system to provide more specific functionality, such as file system service and handling of protected and unprotected data stored in the memory portion 206. Such programs can include, among other things, programming for enabling the device 102 to perform a process such as the process for speech recognition shown in FIG. 3 and discussed further below. Finally, with respect to informational data, this is non-executable code or information that can be referenced and/or manipulated by an operating system or program for performing functions of the device 102.

Referring to FIG. 3, a device 300 according to an embodiment of the invention includes a processor 301, an audio unit 302, a memory 303, and a signal processing and analysis module 304. The audio unit 302 includes one or more microphones. The audio unit 302 receives sound, converts the sound into an audio signal, and provides the audio signal to the signal processing and analysis module 304. The signal processing and analysis module 304 extracts audio information from the audio signal. Such audio information may include the level of background noise, variability of the background noise, spectral shape of the background noise, etc.

Referring still to FIG. 3, the device 300 includes an audio environment determination module 308, a pre-processor selection module 310, a database 312, and a set 314 of auxiliary devices. The set 314 of auxiliary devices includes a GPS module 316, a motion sensor 318, an optical sensor 320, and a temperature sensor 323. The device 300 may also include other auxiliary sensors 324.

The database 312 has one or more data structures that associate different sets of sensory and audio data with different types of audio environments. These data structures may include, for example, one or more lookup tables that contain locations and audio environments that correspond to the locations. Such a lookup table may be created through testing under similar audio environments.

The GPS module 316 receives a GPS signal and determines the location of the device 300 based on the received signal. The GPS module 316 provides information regarding the determined location (“location data”) to the audio environment determination module 308.

The motion sensor 318 senses the motion of the device 300, such as the device 300's acceleration, velocity, and direction. The motion sensor 318 provides the data regarding the sensed motion (“motion data”) to the audio environment determination module 308. In some embodiments, the motion sensor 318 determines the motion of the device 300 and provides the motion data in the form of the appropriate units of distance, speed, etc. In other embodiments, the motion data is raw, in which case the audio environment determination module determines the motion of the device 300 based on the raw data.

The optical sensor 320 senses the light in the vicinity of the device 300 and provides the information regarding the sensed light (“light data”) such as level, color, and images, to the audio environment determination module 308. The optical sensor 320 may include a photo sensor, photo detector, image sensor, or other suitable device.

The temperature sensor 323 may include a thermistor or other similar device. The temperature sensor senses the temperature in the vicinity of the device 300 and provides information regarding the temperature (“temperature data”) to the audio environment determination module 308.

The proximity sensor 327 senses the presence of objects (including people and materials) in the vicinity of the device 300 and provides information regarding this presence (“proximity data”) to the audio environment determination module 308.

The other auxiliary devices 324 gather other auxiliary information and provide this information to the audio environment determination module 308.

The device 300 also includes a set 325 of pre-processors, including first pre-processor 326, a second pre-processor 328, and a third pre-processor 330. The device 300 may also include other pre-processors, represented by a fourth pre-processor 334.

Each of the pre-processors of the set 325 carries out a pre-processing procedure. Possible pre-processor procedures include a one-mic noise suppression procedure, a two-mic noise suppression procedure, and an adaptive noise cancellation procedure. For example, the first pre-processor 326 could carry out a one-mic noise suppression procedure, the second pre-processor 328 could carry out a two-mic noise suppression procedure, and the third pre-processor 330 could carry out an adaptive noise cancellation procedure. The fourth preprocessor 334 could carry out some combination of the first, second, and third preprocessors 326, 328, and 330. As will be discussed, it is possible that the audio signal does not undergo pre-processing at all.

The device 300 further includes a speech recognition module 336 that converts recognized speech signals to text, or carries out the appropriate action in response to the recognized speech or text.

The audio environment determination module 308 receives the audio information from the signal processing and analysis module 304, and receives the auxiliary information from the set 314 of auxiliary devices. The audio environment determination module 308 processes the audio information and the auxiliary information. Using the processed auxiliary information, the audio environment determination module 308 queries the database 312 and receives a response. The audio environment determination module 308 combines the query response with the audio information (received from the signal processing and analysis module 304) to obtain an audio environment type. The audio environment determination module 308 provides data regarding the audio environment type to the pre-processor selection module 310.

Using audio environment type data, the pre-processor selection module 310 determines which pre-processing method will most enhance the ability of the speech recognition module 336 to recognize speech. From the set 325, the pre-processor selection module 310 selects the pre-processor associated with the determined pre-processing method.

The pre-processor selected by the pre-processor selection module 310 pre-processes the input signal and provides the pre-processed signal to the signal recognition module 336. Based on the pre-processed signal, the speech recognition module 336 determines whether the sound constitutes one or more spoken words. If the sound does, the speech recognition module 336 provides the spoken word or words to one or more applications, represented by the application 338 of FIG. 3. Examples of applications include a word processor, a command interface, and an address book.

In one embodiment, the device 300 is capable of carrying out a trigger procedure, in which the device 300 is in a dormant, low-power mode, but is continuously monitoring for trigger words, such as “wake up.” In such an embodiment, the speech recognition module 336 operates in a minimal mode in which it does not react to audio signals until a trigger command is detected. When the speech recognition module 336 detects a trigger command, the speech recognition module 336 sends a message to one or more applications 338. The application 338 in this example may be a method that the operating system calls in order to take the device 300 out of sleep mode.

The ways in which the audio environment determination module 310 uses the auxiliary information to determine the audio environment of the device 300 according to various embodiments of the invention will now be described. It is to be understood that audio environment determination module 310 may not necessarily receive, nor need to receive, data from all of the auxiliary devices of the device 300. Also, the device 300 may only have a subset of the set 314 of auxiliary devices.

The GPS module 316 provides location data to the audio environment determination module 308. The audio environment determination module 308 may determine the audio environment of the device 300 at least in part on the location data. In one embodiment, the audio environment determination module 308 has access to map software/service (such as Google Maps, ©2013 Google) and is able to query the map software/service to determine the address at which the device 300 is located and the type of business at that address. For example, if the audio environment determination module 308 queries the map service with the GPS coordinates and receives the address of a restaurant, the audio environment determination module 308 is likely to conclude that the audio environment is “restaurant.”

The audio environment determination module 308 may also use the location information to determine the velocity of the device 300. In particular, the audio environment determination module 308 receives location data updates from the GPS module 316 at regular intervals, and determines the change in location of the device 300 over time. The audio environment determination module 308 determines, based on the location change determination, the velocity of the device 300. The audio environment determination module 308 may make this velocity determination to determine the audio environment of the device 300. For example, if the audio environment determination module 308 determines that the device 300 is moving more than 20 miles per hour, the audio environment determination module 308 may determine that the device 300 is in a moving vehicle.

The motion sensor 318 provides motion data to the audio environment determination module 308. The audio environment determination module 308 may determine the audio environment of the device 300 based at least in part on the motion data. In one embodiment, the audio environment determination module uses the motion data as a supplement to the location data. In an embodiment, the audio environment determination module 308 uses the location data to determine a starting point for the device 300, and determines, based on the motion data and the starting location, the current location at each time interval. The audio environment determination module 308 then determines an audio environment type based at least in part on the current location of the device 300. This may be done in the same manner as location data received solely from the GPS module 316, which has been previously discussed.

The light sensor 320 provides data regarding the level of illumination (“light data”) to the audio environment determination module 308. The audio environment determination module 308 may determine the audio environment of the device 300 based at least in part on the light data. In one embodiment, the audio environment determination module 308 uses the light data to determine whether the device 300 is indoors, outdoors, or stored away. For example, if the light level is very low, then the audio environment determination module may determine that device 300 is stored away. If the light level is high, then the audio environment determination module may determine that device 300 is outdoors. If is the light level is moderate, then the audio environment determination module may determine that device 300 is indoors.

The temperature sensor 323 provides temperature data to the audio environment determination module 308. The audio environment determination module 308 may determine the audio environment of the device 300 based at least in part on the temperature data. In one embodiment, the audio environment determination module 308 uses the temperature data to determine whether the device 300 is indoors or outdoors. For example, if the temperature is moderate, then the audio environment determination module may determine that device 300 is indoors. If the temperature is high or low, then the audio environment determination module 308 may determine that device 300 is outdoors.

The proximity sensor 327 provides proximity data to the audio environment determination module 308. The audio environment determination module 308 may determine the audio environment of the device 300 based at least in part on the proximity data. In one embodiment, the audio environment determination module 308 uses the proximity data to determine whether the device 300 is stowed (e.g., in a purse) or not. For example, if the proximity data indicates that there are objects all around the device 300, then the audio environment determination module 308 may determine that device 300 is stowed.

Referring to FIG. 4, a set 400 of steps that may be carried out in an embodiment will now be described. At step 402, the audio receiver 302 (FIG. 3) receives sound. At step 404, the audio receiver 302 converts the sound into an audio signal. At step 406, the signal processing and analysis module 304 processes and analyzes the audio signal and provides the resulting audio data to the audio environment determination module 308. At step 408, each of the set 314 of auxiliary devices acquires the auxiliary data and provides auxiliary data to the audio environment determination module 308 as previously described. At step 410, the audio environment determination module 308 queries the database 312 using the auxiliary data from the auxiliary devices 314, combines the result of the query with the audio data received from the signal processing and analysis module 304 in order to determine an audio environment type for the device 300, and provides data regarding the audio environment type to the pre-processor selection module 310. At step 412 the pre-processor selection module 310 determines which pre-processing method (procedure) will most enhance the ability of the speech recognition module 336 to recognize speech. At step 414, the selected pre-processor pre-processes the audio signal according to the determined method and provides the pre-processed audio signal to the speech recognition module 336.

It can be seen from the foregoing that a method and apparatus for pre-processing audio signals has been provided. In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof

What is claimed is:

1. A method, in an electronic device, the method comprising:
receiving an audio signal comprising audio information;
obtaining auxiliary information;
determining, based on the audio information and the auxiliary information, a type of audio environment in which the electronic device is operating;
selecting an audio pre-processing procedure from a plurality of pre-defined audio pre-processing procedures based on the determined audio environment type; and
pre-processing the audio signal according to the selected pre-processing procedure.

2. The method of claim 1, further comprising performing speech recognition on the pre-processed audio signal.

3. The method of claim 1, wherein determining the type of audio environment comprises determining whether the electronic device is operating in at least one of a plurality of audio environments, including: in a vehicle, in a home, in a restaurant, in an office, and on a street.

4. The method of claim 1, wherein obtaining auxiliary information comprises:
receiving a global positioning system signal; and
determining the location of the electronic device based on the global positioning system signal, wherein the auxiliary information includes the determined location.

5. The method of claim 1, wherein obtaining auxiliary information comprises:
receiving a global positioning system signal; and
determining the velocity of the electronic device based on the global positioning system signal, wherein the auxiliary information includes the determined velocity.

6. The method of claim 1, wherein obtaining auxiliary information comprises:
receiving a global positioning system signal;
determining the location of the electronic device based on the global positioning system signal; and
determining the velocity of the electronic device based on the global positioning system signal, wherein the auxiliary information includes the determined location and the determined velocity.

7. The method of claim 1, wherein the plurality of pre-defined audio pre-processing procedures comprises a procedure selected from the group consisting of straight-through signal transmission, single microphone noise suppression, two microphone noise suppression, and adaptive noise cancellation.

8. The method of claim 1, wherein obtaining auxiliary information comprises:
sensing light; and
determining, based on the sensed light, the type of audio environment in which the electronic device is operating.

9. The method of claim 1, wherein obtaining the auxiliary information comprises determining the velocity of the electronic device based on a signal from a motion sensor.

10. A electronic device comprising:
an auxiliary device;
a processor that:
receives an audio signal comprising audio information;
receives auxiliary information from the auxiliary device;
determines, based on the audio information and the auxiliary information, a type of audio environment in which the electronic device is operating; and
selects an audio pre-processing procedure from a plurality of pre-defined audio pre-processing procedures based on the determined audio environment type; and
an audio pre-processor module that carries out the selected audio pre-processing procedure on the audio signal to generate a pre-processed audio signal.

11. The electronic device of claim 10, further comprising a speech recognition module that carries out speech recognition on the pre-processed audio signal.

12. The electronic device of claim 10, further comprising:
a global positioning system module that determines a location based on a global positioning system signal, wherein the auxiliary information includes the determined location.

13. The electronic device of claim 10, further comprising:
an optical sensor that determines optical data relating the brightness and color of light in the vicinity of the electronic device, wherein the auxiliary information includes the optical data.

14. The electronic device of claim 10, wherein the plurality of pre-defined audio pre-processing procedures comprises a pre-defined processing procedure selected from the group consisting of straight-through signal transmission, single microphone noise suppression, two microphone noise suppression, and adaptive noise cancellation.

15. The electronic device of claim 10, further comprising a speech recognition module that converts the pre-processed audio signal into textual data and provides the textual data to an application program.

16. The electronic device of claim 15, wherein the application program is chosen from a group consisting of a user interface, and address book, a dialer, and an instant messaging program.

17. The electronic device of claim 16, wherein the application program processes the textual data.

18. A non-transitory computer readable storage medium having stored thereon a program executable by a computing processor to perform a method, the method comprising:
receiving an audio signal comprising audio information;
obtaining auxiliary information;
determining, based on the audio information and the auxiliary information, a type of audio environment in which the electronic device is operating;
selecting an audio pre-processing procedure from a plurality of pre-defined audio pre-processing procedures based on the determined audio environment type; and
pre-processing the audio signal according to the selected pre-processing procedure.

19. The non-transitory computer readable storage medium of claim 18, wherein obtaining auxiliary information comprises:
receiving a global positioning system signal; and
determining the location of the electronic device based on the global positioning system signal, wherein the auxiliary information includes the determined location.

20. The non-transitory computer readable storage medium of claim 18, wherein the plurality of pre-defined audio pre-processing procedures comprises a procedure selected from the group consisting of straight-through signal transmission, single microphone noise suppression, two microphone noise suppression, and adaptive noise cancellation.
